(19) United States
(12) Patent Application Publication
(10) Pub. No.: US 2008/0102929 A1
(43) Pub. Date: May 1, 2008

(54) Gaming machine and playing method thereof

(75) Inventor: Yukinori Inamura, Tokyo (JP)

Correspondence Address: ARENT FOX LLP, 1050 CONNECTICUT AVENUE, N.W., SUITE 400, WASHINGTON, DC, 20036, US

(73) Assignee: Aruze Corporation

(21) Appl. No.: 11/907,626

(22) Filed: Oct. 15, 2007

(30) Foreign Application Priority Data
Oct. 16, 2006 (JP) 2006-280948

(51) Int. Cl. G07F 17/34; A63F 13/00; A63F 9/24; G06F 19/00

(52) U.S. Cl. 463/20

(57) ABSTRACT

Rearrangement symbol data that relate to rearrangement symbols are received from a host computer 200 that determines rearrangement symbols for every unit game. Based on the rearrangement symbol data, a plurality of symbols 180 are rearranged. An award is given based on the plurality of symbols 180 thus rearranged.

### CROSS REFERENCE TO RELATED APPLICATION

This application is based upon and claims the benefit of priority from the prior Japanese patent Application No. 2006-280948, filed on Oct. 16, 2006.

### BACKGROUND OF THE INVENTION

1. Field of the Invention

The present invention relates to a gaming machine, and a playing method of the gaming machine.

2. Description of Related Art

In a conventional gaming machine, when a player inserts a game medium such as a coin, a bill and the like into an insertion slot of the gaming machine and then inputs a spin button, symbols are scrollingly displayed on a display that is provided on a front face of a cabinet, and then the respective symbols are automatically stopped.

In such a gaming machine, a predetermined number of game media are paid out on a condition that a predetermined combination of symbols is stopped on a winning line, as disclosed in the description of U.S. Pat. No. 6,604,999 or the description of United States Patent Application Publication No. 2002065124 for example. In addition, a predetermined number of game media are further paid out in accordance with the number of symbols called scatter symbols being displayed on the display irrespective of the winning line. That is, the conventional gaming machine performs a payout using a combination of two manners.

### SUMMARY OF THE INVENTION

In the conventional gaming machine, however, whether a win allowing a game medium to be paid out occurs or not is determined at the inside of each gaming machine. This causes a problem that, in a casino or the like where several gaming machines are placed, a payout of game media in each gaming machine cannot sufficiently be managed.

An object of the present invention is to provide a gaming machine and a playing method of the gaming machine having entertainment value that cannot be found in the conventional technique mentioned above.

In addition, an object of the present invention is to provide a gaming machine and a playing method of the gaming machine that allows a casino or the like to easily manage a payout of game media.

A gaming machine of the present invention comprises a display on which a plurality of symbols are arranged; a communication device that is data-communicably connected to a host computer that determines rearrangement symbols for every unit game; and a controller programmed to perform operations of: (a) rearranging the plurality of symbols based on a rearrangement symbol data item that relates to the rearrangement symbols received by the communication device from the host computer; and (b) giving an award based on the plurality of symbols thus rearranged.

According to the above structure, rearrangement symbols are determined by the host computer. Therefore, by managing the host computer, a casino or the like can easily grasp a state of giving of awards from the gamine machine.

In addition, a gaming machine of the present invention comprises a display on which a plurality of symbols are arranged; a communication device that is data-communicably connected to a host computer, wherein the host computer determines rearrangement symbols for every unit game with respect to each gaming machine in a case where the number of in-operation gaming machines is smaller than a predetermined value, while the host computer divides all gaming machines into a plurality of groups and determines rearrangement symbols for every unit game with respect to each group in a case where the number of in-operation gaming machines is greater than the predetermined value; and a controller programmed to perform operations of: (a) transmitting a signal indicating that the gaming machine is in operation, from the communication device to the host computer; (b) rearranging the plurality of symbols based on a rearrangement symbol data item that relates to the rearrangement symbols received by the communication device from the host computer; and (c) giving an award based on the plurality of symbols thus rearranged.

According to the above structure, rearrangement symbols are determined by the host computer. Therefore, by managing the host computer, a casino or the like can easily grasp a state of giving of awards from the gamine machine. In addition, when many gaming machines are in operation, a burden is put on a processing capacity of the host computer that determines rearrangement symbols for each gaming machine. However, since the host computer divides all the gaming machines into several groups and determines rearrangement symbols for each group, the burden put on the processing capacity of the host computer can be reduced.

In addition, a gaming machine of the present invention comprises a display on which a plurality of symbols are arranged; a communication device that is data-communicably connected to a host computer, wherein the host computer determines rearrangement symbols for every unit game, and determines the rearrangement symbols so as to reduce a payout rate, which is a probability that an award will be given, in a case where the payout rate is higher than a predetermined probability; and a controller programmed to perform operations of: (a) transmitting a payout rate data item that relates to the payout rate, from the communication device to the host computer; (b) rearranging the plurality of symbols based on a rearrangement symbol data item that relates to the rearrangement symbols received by the communication device from the host computer; (c) giving an award based on the plurality of symbols thus rearranged; and (d) calculating the payout rate.

According to the above structure, rearrangement symbols are determined by the host computer. Therefore, by managing the host computer, a casino or the like can easily grasp a state of giving of awards from the gamine machine. In addition, by reflecting the payout rate to the host computer, the payout rate in the gaming machine higher than the predetermined probability can be reduced. As a result, the number of games to be played by a player desiring a large amount of award can be increased, and therefore an operation rate of the gaming machine can be increased.

In addition, a gaming machine of the present invention comprises a display on which a plurality of symbols are arranged; a communication device that is data-communicably connected to a host computer, wherein the host computer determines rearrangement symbols for every unit game with respect to each gaming machine in a case where the number of in-operation gaming machines is smaller than a predetermined value, while the host computer divides all gaming machines into a plurality of groups and determines rearrangement symbols for every unit game with respect to each group in a case where the number of in-operation gaming machines is greater than the predetermined value, and in addition the host computer determines the rearrangement symbols so as to reduce a payout rate, which is a probability that an award will be given, in a case where the payout rate is higher than a predetermined probability; and a controller programmed to perform operations of: (a) transmitting a signal indicating that the gaming machine is in operation and a payout rate data item that relates to the payout rate, from the communication device to the host computer; (b) rearranging the plurality of symbols based on a rearrangement symbol data item that relates to the rearrangement symbols received by the communication device from the host computer; (c) giving an award based on the plurality of symbols thus rearranged; and (d) calculating the payout rate.

According to the above structure, rearrangement symbols are determined by the host computer. Therefore, by managing the host computer, a casino or the like can easily grasp a state of giving of awards from the gamine machine. In addition, when many gaming machines are in operation, a burden is put on a processing capacity of the host computer that determines rearrangement symbols for each gaming machine. However, since the host computer divides all the gaming machines into several groups and determines rearrangement symbols for each group, the burden put on the processing capacity of the host computer can be reduced. In addition, by reflecting the payout rate to the host computer, the payout rate in the gaming machine higher than the predetermined probability can be reduced. As a result, the number of games to be played by a player desiring a large amount of award can be increased, and therefore an operation rate of the gaming machine can be increased.

According to the present invention, there is provided a playing method of a gaming machine wherein a controller repeatedly performs a unit game in which a plurality of symbols arranged on a display are rearranged. The method comprises the steps of: (a) rearranging the plurality of symbols based on a rearrangement symbol data item that relates to rearrangement symbols received from a host computer that determines rearrangement symbols for every unit game; and (b) giving an award based on the plurality of symbols thus rearranged.

According to the above structure, rearrangement symbols are determined by the host computer. Therefore, by managing the host computer, a casino or the like can easily grasp a state of giving of awards from the gamine machine.

According to the present invention, there is provided a playing method of a gaming machine wherein a controller repeatedly performs a unit game in which a plurality of symbols arranged on a display are rearranged. The method comprises the steps of: (a) transmitting to a host computer a signal indicating that the gaming machine is in operation, wherein the host computer determines rearrangement symbols for every unit game with respect to each gaming machine in a case where the number of in-operation gaming machines is smaller than a predetermined value, while the host computer divides all gaming machines into a plurality of groups and determines rearrangement symbols for every unit game with respect to each group in a case where the number of in-operation gaming machines is greater than the predetermined value; (b) rearranging the plurality of symbols based on a rearrangement symbol data item that relates to the rearrangement symbols received from the host computer; and (c) giving an award based on the plurality of symbols thus rearranged.

According to the above structure, rearrangement symbols are determined by the host computer. Therefore, by managing the host computer, a casino or the like can easily grasp a state of giving of awards from the gamine machine. In addition, when many gaming machines are in operation, a burden is put on a processing capacity of the host computer that determines rearrangement symbols for each gaming machine. However, since the host computer divides all the gaming machines into several groups and determines rearrangement symbols for each group, the burden put on the processing capacity of the host computer can be reduced.

According to the present invention, there is provided a playing method of a gaming machine wherein a controller repeatedly performs a unit game in which a plurality of symbols arranged on a display are rearranged. The method comprises the steps of: (a) calculating a payout rate which is a probability that an award will be given; (b) transmitting to a host computer a payout rate data item that relates to the payout rate, wherein the host computer determines rearrangement symbols for every unit game, and determines the rearrangement symbols so as to reduce the payout rate in a case where the payout rate is higher than a predetermined probability; (c) rearranging the plurality of symbols based on a rearrangement symbol data item that relates to the rearrangement symbols received from the host computer; and (d) giving an award based on the plurality of symbols thus rearranged.

According to the above structure, rearrangement symbols are determined by the host computer. Therefore, by managing the host computer, a casino or the like can easily grasp a state of giving of awards from the gamine machine. In addition, by reflecting the payout rate to the host computer, the payout rate in the gaming machine higher than the predetermined probability can be reduced. As a result, the number of games to be played by a player desiring a large amount of award can be increased, and therefore an operation rate of the gaming machine can be increased.

According to the present invention, there is provided a playing method of a gaming machine wherein a controller repeatedly performs a unit game in which a plurality of symbols arranged on a display are rearranged. The method comprises the steps of: (a) calculating a payout rate which is a probability that an award will be given; (b) transmitting to a host computer a signal indicating that the gaming machine is in operation and a payout rate data item that relates to the payout rate, wherein the host computer determines rearrangement symbols for every unit game with respect to each gaming machine in a case where the number of in-operation gaming machines is smaller than a predetermined value, while the host computer divides all gaming machines into a plurality of groups and determines rearrangement symbols for every unit game with respect to each group in a case where the number of in-operation gaming machines is greater than the predetermined value, and in addition the host computer determines the rearrangement symbols so as to reduce the payout rate in a case where the payout rate is higher than a predetermined probability; (c) rearranging the plurality of symbols based on a rearrangement symbol data item that relates to the rearrangement symbols received from the host computer; and (d) giving an award based on the plurality of symbols thus rearranged.

According to the above structure, rearrangement symbols are determined by the host computer. Therefore, by managing the host computer, a casino or the like can easily grasp a state of giving of awards from the gamine machine. In addition, when many gaming machines are in operation, a burden is put on a processing capacity of the host computer that determines rearrangement symbols for each gaming machine. However, since the host computer divides all the gaming machines into several groups and determines rearrangement symbols for each group, the burden put on the processing capacity of the host computer can be reduced. In addition, by reflecting the payout rate to the host computer, the payout rate in the gaming machine higher than the predetermined probability can be reduced. As a result, the number of games to be played by a player desiring a large amount of award can be increased, and therefore an operation rate of the gaming machine can be increased.

With the above-described constructions, there can be provided a gaming machine and a playing method of the gaming machine having entertainment value that cannot be found in the conventional technique.

### BRIEF DESCRIPTION OF THE DRAWINGS

Other and further objects, features and advantages of the invention will appear more fully from the following description taken in connection with the accompanying drawings in which:

FIG. 1 is an explanatory view showing a playing method for a gaming machine;

FIG. 2 is a block diagram of the gaming machine;

FIG. 3 is an explanatory view of a display screen;

FIG. 4 shows symbols and code numbers of the respective symbols;

FIG. 5 is an explanatory view showing a relationship between gaming machines and a host computer;

FIG. 6 is a perspective view showing an appearance of the gaming machine;

FIG. 7 is a block diagram showing a control circuit of the gaming machine;

FIG. 8 is a block diagram showing a control circuit of the host computer;

FIG. 9A shows a result of determination of a combination upon rearrangement;

FIG. 9B shows a result of determination of a combination upon rearrangement;

FIG. 10 is a flowchart showing a signal reception processing;

FIG. 11 is a flowchart showing a game execution processing;

FIG. 12 is a flowchart showing a grouping processing; and

FIG. 13 is a flowchart showing a combination determination processing.

### DESCRIPTION OF THE PREFERRED EMBODIMENTS

A description will be given to an embodiment of a gaming machine and a playing method of the gaming machine according to the present invention.

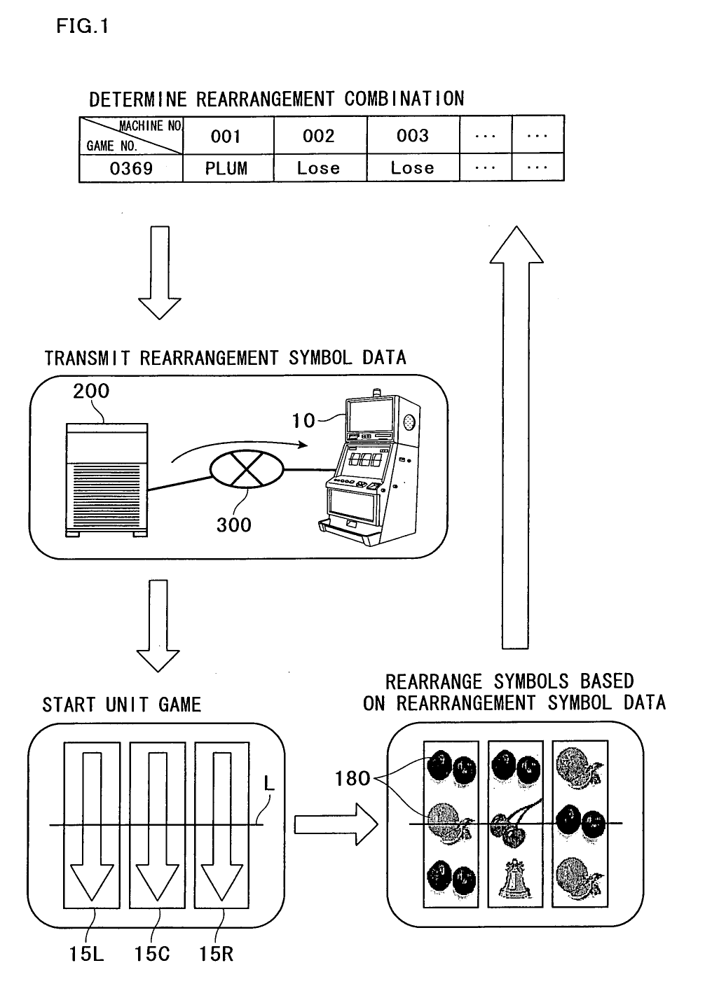

As shown in FIG. 1, a gaming machine executes a playing method that includes the steps of: arranging symbols on a display; rearranging symbols based on rearrangement symbol data relating to rearrangement symbols and received from a host computer that determines rearrangement symbols for every unit game; and giving an award based on the symbols thus rearranged.

Here, the term “arrange” means bringing a symbol 180 in such a state that a player existing outside can visibly check the symbol 180. That is, in FIG. 1, it means that the symbols 180 are displayed in display windows 15L, 15C, and 15R. The term “rearrange” means arranging symbols 180 again after dismissing the arrangement of symbols 180.

Further, a gaming machine 10 executes a playing method that includes the steps of: calculating a payout rate which is a probability that an award will occur; transmitting to the host computer a signal indicating that the gaming machine 10 is in operation; and transmitting to the host computer payout rate data that relates to a payout rate.

[Display 101]

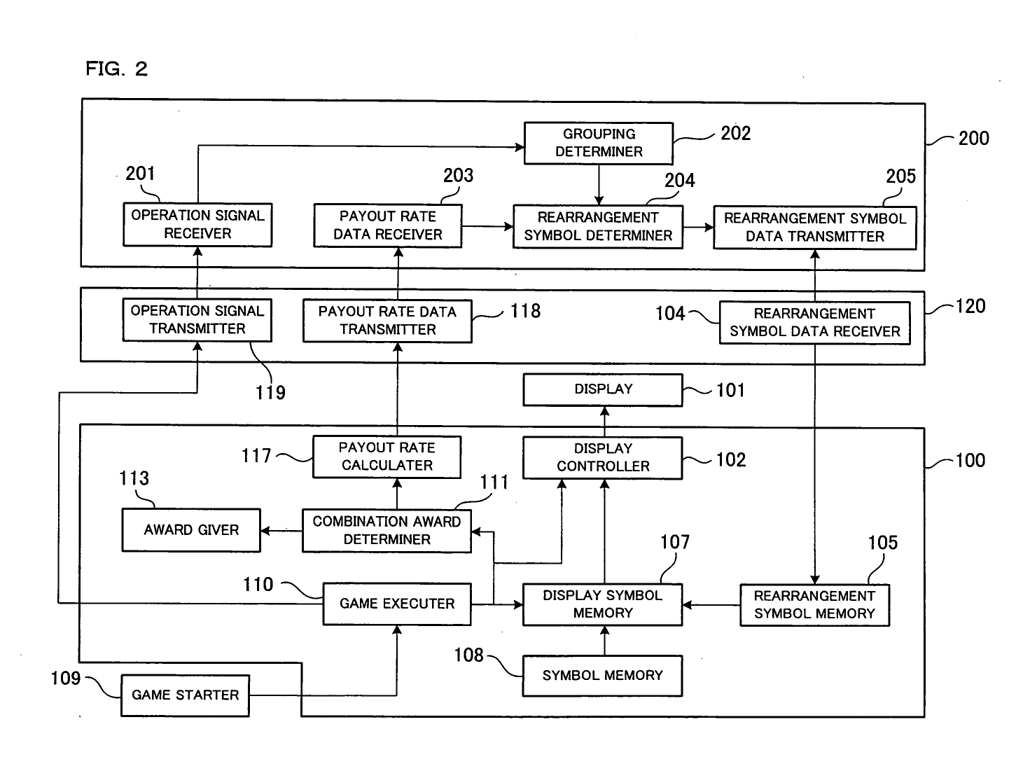

The gaming machine that executes the above-described playing method has a display 101, a communication device 120, and a controller 100, as shown in FIG. 2. The display 101 is adapted to arrange symbols thereon.

The display 101 may have a mechanical construction with a reel device that arranges symbols by rotation of a reel, or alternatively an electrical construction that arranges symbols using a video reel being image-displayed. Further alternatively, the display 101 may be a combination of a mechanical construction (reel) and an electrical construction (video reel). For the electrical construction, a liquid crystal display device, a CRT (cathode-ray tube), a plasma display device, and the like may be mentioned. A specific construction of the display 101 will be described later.

[Communication Device 120]

The communication device 120 includes an operation signal transmitter 119, a payout rate data transmitter 118, and a rearrangement symbol data receiver 104. The operation signal transmitter 119 transmits to a host computer 200 an operation signal that indicates that the gaming machine is in operation. The payout rate data transmitter 118 transmits to the host computer 200 payout rate data that relate to a payout rate calculated by the controller 100. The rearrangement symbol data receiver 104 receives from the host computer 200 rearrangement symbol data that relate to rearrangement symbol.

[Controller 100]

The controller 100 is adapted to execute a first processing and a second processing. The first processing is to rearrange symbols 180 based on rearrangement symbol data. The rearrangement symbol data relate to rearrangement symbols and are received from the host computer 200 that determines rearrangement symbols for every unit game. The second processing is to give an award based on the rearranged symbols 180. In other words, the controller 100 has a first processor and a second processor.

Further, the controller 100 is adapted to execute a third processing, a fourth processing, and a fifth processing. The third processing is to transmit to the host computer 200 a signal indicating that the gaming machine is in operation. The fourth processing is to calculate a payout rate which is a probability that an award will be given. The fifth processing is to transmit to the host computer 200 payout rate data that relate to the payout rate. In other words, the controller 100 has a third processor, a fourth processor, and a fifth processor, in addition to the first processor and the second processor.

The above-described controller 100 has a symbol memory 108 and a display symbol memory 107. The symbol memory 108 stores all symbols therein. The display symbol memory 107 stores therein symbols for being displayed, among the symbols stored in the symbol memory 108. The display symbol memory 107 is accessible by a display controller 102. Based on a control by a game executer 110, the display controller 102 reads out symbols from the display symbol memory 107, and displays symbols on the display 101. A specific display state will be described later.

The controller 100 also has a rearrangement symbol memory 105 that stores therein rearrangement symbols relating to rearrangement symbol data received by the rearrangement symbol data receiver 104 of the communication device 120. The rearrangement symbols stored in the rearrangement symbol memory 105 are outputted to the display symbol memory 107, and then used for an image processing performed by the display controller 102. Thereby, the rearrangement symbols are displayed on the display 101. That is, the controller 100 executes the first processing to rearrange symbols based on the rearrangement symbol data.

Further, the controller 100 is connected to a game starter 109. The game starter 109 has a function to output a game start signal by an operation made by a player. The controller 100 has a game executer 110, a combination award determiner 111, and a award giver 113. Triggered by the game start signal from the game starter 109, the game executer 110 transmits the operation signal to the host computer 200 and in addition executes a unit game in which symbols 180 are rearranged. The combination award determiner 111 determines an award that is set by a combination of symbols 180 rearranged in the unit game. The award giver 113 gives each award determined by the combination award determiner 111.

The controller 100 further has a payout rate calculator 117 that calculates a payout rate based on an award determined by the combination award determiner 111.

Each block of the controller 100 may be formed by a hardware or by a software if necessary.

[Host Computer 200]

As shown in FIG. 2, the host computer 200 has an operation signal receiver 201 that receives an operation signal from the operation signal transmitter 119 of the communication device 120. The host computer 200 also has a grouping determiner 202 that divides the gaming machines 10 into several groups when the number of operation signals received by the operation signal receiver 201 is equal to or greater than a predetermined value, that is, when the number of in-operation gaming machines 10 is greater than a predetermined value.

The host computer 200 has a payout rate data receiver 203 that receives payout rate data from the payout rate data transmitter 118 of the communication device 120. The host computer 200 also has a rearrangement symbol determiner 204 that determines rearrangement symbols for every unit game. When the grouping determiner 202 determines that the gaming machines 10 should be divided into groups, the rearrangement symbol determiner 204 determines rearrangement symbols for each group, while when the grouping determiner 202 does not determine that the gaming machines 10 should be divided into groups, the rearrangement symbol determiner 204 determines rearrangement symbols for each gaming machine 10. The rearrangement symbol determiner 204 refers to the payout rate data received by the payout rate data receiver 203, and determines rearrangement symbols so as to reduce the payout rate in the gaming machine 10 higher than a predetermined probability. Symbols determined by the rearrangement symbol determiner 204 are, as rearrangement symbol data, transmitted from a rearrangement symbol data transmitter 205 to the communication device 120.

Like this, rearrangement symbols are determined by the host computer 200. Therefore, by managing the host computer 200, a casino or the like can easily grasp a state of giving of awards from the gamine machines 10.

When many gaming machines 10 are in operation, a burden is put on a processing capacity of the host computer 200 that determines rearrangement symbols for each gaming machine 10. However, since the host computer 200 divides all the gaming machines 10 into several groups and determines rearrangement symbols for each group, the burden put on the processing capacity of the host computer 200 can be reduced. In addition, by reflecting the payout rate to the host computer 200, the payout rate in the gaming machine 10 higher than the predetermined probability can be reduced. As a result, the number of games to be played by a player desiring a large amount of award can be increased, and therefore an operation rate of the gaming machine 10 can be increased.

[Operation of Controller 100]

An operation of the controller 100 in the above-described construction will be described. First, an operation signal indicating that the gaming machine is in operation is transmitted to the host computer 200. Here, the controller 100 executes the third processing to transmit to the host computer 200 the signal indicating that the gaming machine is in operation. In accordance with the number of operation signals received by the operation signal receiver 201, the host computer 200 determines rearrangement symbols for every group or determines rearrangement symbols for every gaming machine.

Then, the current payout rate is calculated by the payout rate calculator 117 and, as payout rate data, transmitted from the payout rate data transmitter 118 to the host computer 200. Here, the controller 100 executes the fourth processing to calculate a payout rate which is a probability that an award will be given, and the fifth processing to transmit payout rate data relating to the payout rate to the host computer 200. Based on the payout rate, the host computer 200 determines whether rearrangement symbols should be set so as to reduce the payout rate, or not.

Then, rearrangement symbol data relating to rearrangement symbols determined by the host computer 200 are, as rearrangement symbols, stored in the rearrangement symbol memory 105 through the rearrangement symbol data receiver 104. The rearrangement symbols stored in the rearrangement symbol memory 105 are stored into the display symbol memory 107. The display controller 102 enables rearrangement symbols in the display symbol memory 107 to be displayed on the display 101. When the game executer 110 executes a unit game, the rearrangement symbols in the display symbol memory 107 are displayed on the display 101, so that symbols 180 are rearranged. Here, the controller 100 executes the first processing to rearrange symbols 180 based on the rearrangement symbol data.

Then, an award based on the rearranged symbols is given by the combination award determiner 111 and the award giver 113. Here, the controller 100 executes the second processing to give an award based on the rearranged symbols 180.

As clearly seen from the above-described operation and as shown also in FIG. 1, the gaming machine 10 realizes a playing method including: calculating a payout rate which is a probability that an award will be given; determining rearrangement symbols for every unit game with respect to each gaming machine 10 when the number of in-operation gaming machines 10 is smaller than a predetermined value while dividing all gaming machines 10 into several groups and determining rearrangement symbols for every unit game with respect to each group when the number of in-operation gaming machines 10 is greater than a predetermined value; when a payout rate is higher than a predetermined probability, transmitting a signal indicating that the gaming machine 10 is in operation and payout rate data relating to the payout rate to the host computer 200 that determines rearrangement symbols so as to reduce the payout rate; rearranging symbols 180 based on rearrangement symbol data relating to the rearrangement symbols received from the host computer 200; and giving an award based on the rearranged symbols 180.

[Display State]

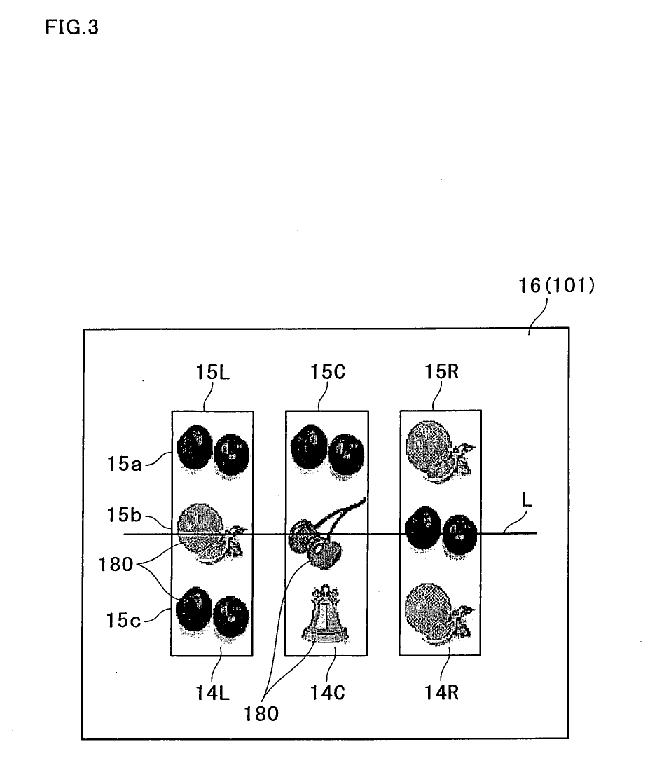

Here, a specific description will be given to one exemplary display state on the display 101 in an operation process of the above-described gaming machine 10 and the playing method. The description of the display state which will be given below is based on such a construction that the display 101 arranges symbols using a mechanical reel method as shown in FIG. 3.

The display 101 has display windows 15L, 15C, and 15R as arrangement regions where symbols 180 are arranged. The display windows 15L, 15C, and 15R are provided in a central part of the display 101. In the display windows 15L, 15C, and 15R, reels 14L, 14C, and 14R having columns of symbols 180 painted thereon are rotated (see FIG. 1). Each of the display windows 15L, 15C, and 15R is divided into an upper section 15a, a middle section 15b, and a lower section 15c. Symbols are stopped (arranged) in the respective sections 15a, 15b, and 15c. In FIG. 3, for example, a “PLUM” symbol is stopped on the upper section 15a of the display window 15L, a “ORANGE” symbol is stopped on the middle section 15b of the display window 15L, and a “PLUM” symbol is stopped on the lower section 15c of the display window 15L. The display windows 15L, 15C, and 15R show a symbol matrix made up of three columns and three rows. Here, the symbol matrix is not limited to the one made up of three columns and three rows.

A payline L that extends horizontally across the middle sections 15b of the respective display windows 15L, 15C, and 15R is provided. The payline L is for determining a combination of symbols 180. That is, when symbols 180 are rearranged on the payline L and outside the payline L, only the symbols 180 rearranged on the payline L are involved in determination of a combination. When a winning combination is made as a result of the determination of a combination, a processing such as paying out coins is performed based on the winning combination.

In this embodiment, the payline L is provided, and the processing such as paying out coins is performed on a condition that a predetermined combination of symbols is stopped on the payline L. However, it may also be acceptable that the processing such as paying out coins is performed on a condition that a predetermined number of symbols called scatter symbols are displayed on the display 101 irrespective of the payline L.

[Symbol, Combination, and the Like]

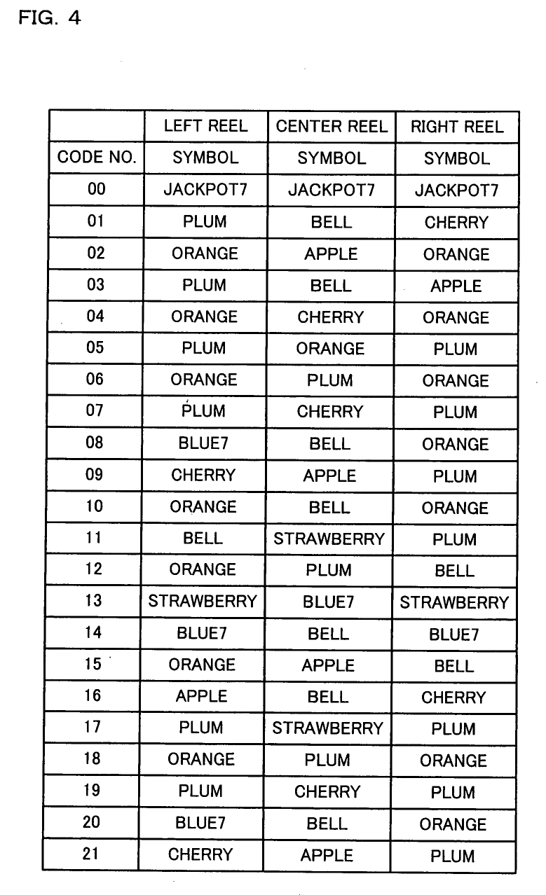

As shown in FIG. 4, twenty-two symbols that constitute a column is painted on an outer surface of each of the left reel 14L, the center reel 14C, and the right reel 14R. Any of code numbers 0 to 21 is given to each symbol included in each column. Each column of symbols is a combination of “JACKPOT 7” symbols, “BLUE 7” symbols, “BELL” symbols, “CHERRY” symbols, “STRAWBERRY” symbols, “PLUM” symbols, “ORANGE” symbols, and “APPLE” symbols.

Three consecutive symbols in the column of symbols are displayed (arranged) in the upper section 15a, the middle section 15b, and the lower section 15c of each of the display windows 15L, 15C, and 15R, so that the display windows 15L, 15C, and 15R form the symbol matrix including three columns and three rows. When a 1-BET button 26 or a MAX-BET button 27 is pressed and then a spin button 23 is pressed to start a game, the columns of symbols painted on the respective reels 14 are displayed scrollingly from up to down in the display windows 15 along with rotation of the reels 14. After a predetermined period of time has elapsed, rotation of the reels 14 is stopped and accordingly the columns of symbols are stopped in the display windows 15 (rearrangement).

For each symbol, various winning combinations are set in advance. The winning combination means a combination of symbols that give a player an advantage when stopped on the payline L. Here, the advantage means paying out coins corresponding to the winning combination, adding the number of coins paid out to a credit value, starting a bonus game, or the like.

More specifically, when an “APPLE” symbol combination is stopped on the payline L, a bonus trigger appears so that a game state is shifted from a basic game to a bonus game. When a “CHERRY” symbol is stopped on the payline L, twenty coins (game media) per bet are paid out. When a “PLUM” symbol is stopped on the payline L, five coins per bet are paid out.

The bonus game is more advantageous than the basic game. In this embodiment, the bonus game is a free game. The free game means a game that allows a player to play a predetermined number of games without betting any coin. No particular limitation is put on the bonus game as long as the bonus game is advantageous to a player, that is, the bonus game is more advantageous than the basic game. For example, the bonus game may be a game in which a player can obtain more game media than in the basic game, a game in which a player can obtain game media with a higher probability than in the basic game, a game in which the number of consumed game media is smaller than in the basic game, or the like. To be more specific, a free game, a second game, or the like may be mentioned as the bonus game.

[Mechanical Construction of Gaming Machine 10]

Next, a description will be given to one mode of the above-described gaming machine 10 having a specific mechanical and electrical construction.

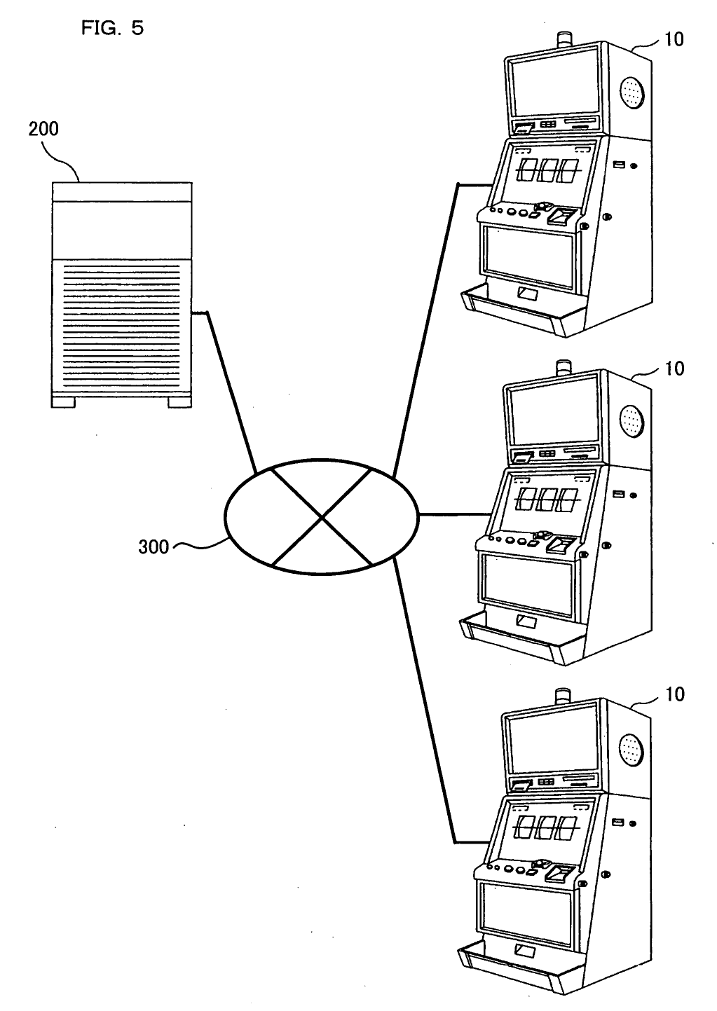

As shown in FIG. 5, several gaming machines 10 are placed in a game arcade. The respective gaming machines 10 are connected to the host computer 200 communicably through an internet communication network 300.

The gaming machine 10 executes a unit game using a game medium. The game medium is a coin, a bill, or valuable electronic information equivalent thereto. In the present invention, the game medium is not particularly limited, and may be a medal, a token, electronic money, a ticket or the like for example. No particular limitation is put on the ticket. For example, a barcoded thicket which will be described later is also acceptable.

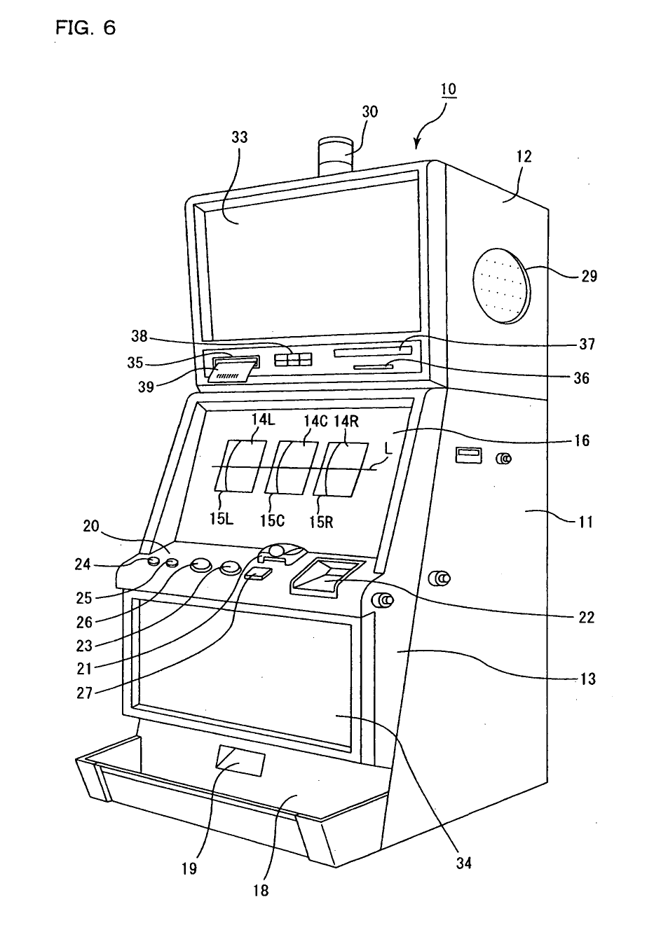

As shown in FIG. 6, the gaming machine 10 includes a cabinet 11, a top box 12 placed on an upper side of the cabinet 11, and a main door 13 provided on a front face of the cabinet 11. Inside the cabinet 11, three rotatable reels 14 (14L, 14C, and 14R) are provided. A column of symbols, which includes twenty-two symbols, is painted on an outer surface of each reel 14.

On the main door 13, a lower image display panel 16 is provided in front of the reels 14. The lower image display panel 16 has a transparent liquid crystal panel that displays various information thereon. During a game, various information relating to the game, effect images, and the like is displayed on the lower image display panel 16.

Three see-through display windows 15 (15L, 15C, and 15R) are formed in a central part of the lower image display panel 16. Through each of the display windows 15, three of the symbols painted on the outer surface of each reel 14 are displayed. One activated payline L is displayed on the lower image display panel 16. The activated payline L horizontally extends across the three display windows 15. The payline L is set so as to extend horizontally across the middle sections 15b of the display windows 15L, 15C, and 15R. Although in this embodiment the payline L extends across the middle sections 15b of the display windows 15L, 15C, and 15R, the payline L may extend across another section of each of the display windows 15L, 15C, and 15R. For example, the payline L may extend across the upper sections 15a or the lower sections 15c of the display windows 15L, 15C, and 15R. Alternatively, the payline L may extend across the lower section 15c of the display window 15L, the middle section 15b of the display window 15C, and the upper section 15a of the display window 15R. Moreover, two or more paylines L may be provided. In a case where there are two or more paylines L, all the paylines L may be activated or alternatively the number of activated paylines L may depend on a predetermined condition such as the number of coins bet.

In this embodiment, as an example, symbols are displayed through the display windows 15 by rotating and stopping the mechanical reels 14 having symbols put on their surfaces. However, this is not limitative, and three columns and three rows of symbol images may be displayed using the lower image display panel 16.

A credit value indicator and a payout number indicator may be displayed on the lower image display panel 16. In the credit value indicator, the total number of game media payable from the gaming machine 10 to a player (hereinafter referred to also as a total credit value) is indicated. In the payout number indicator, the number of coins which will be paid out on condition that a combination of symbols stopped on a payline is a winning combination.

A touch panel 69 is provided on a front face of the lower image display panel 16. The touch panel 69 has several contact portions arranged in a matrix in longitudinal and lateral directions. Therefore, positional information showing a longitudinal and lateral position of a pressed contact portion can be outputted as a command signal. Here, a touch panel adopted in a mobile terminal, an automated-teller machine (ATM) of a bank or the like may be used for the touch panel 69.

A control panel 20, a coin reception slot 21, and a bill discriminator 22 are provided on a lower side of the lower image display panel 16. The control panel 20 has buttons 23 to 27. These buttons enable a player to input a command about a game progress. The coin reception slot 21 enables a coin to be received into the cabinet 11.

The control panel 20 has a spin button 23, a change button 24, a cashout button 25, a 1-BET button 26, and a MAX-BET button 27. The spin button 23 is a button for inputting a command to start rotation of the reels 14. The change button 24 is a button used when asking a staff of a game arcade for an exchange. The cashout button 25 is a button for inputting a command to pay out coins, the number of which is equivalent to a total credit value, into a coin tray 18.

The 1-BET button 26 is a button for inputting a command to bet on a game one coin among coins equivalent to a total credit value. The MAX-BET button 27 is a button for inputting a command to bet on a game a maximum coins (e.g., 50 coins) bettable on one game among coins equivalent to a total credit value.

The bill discriminator 22 determines whether a bill is a proper one or not, and admits a proper bill into the cabinet 11. The bill discriminator 22 can read a barcoded ticket 39 which will be described later. When the bill discriminator 22 reads a barcoded ticket 39, the bill discriminator 22 outputs to a main CPU 41a read signal that relates to read contents.

A belly glass 34 is provided on a lower part of a front face of the main door 13, that is, provided below the control panel 20. A character of the gaming machine 10 or the like is painted on the belly glass 34. An upper image display panel 33 is provided on a front face of the top box 12. The upper image display panel 33 has a liquid crystal panel. For example, effect images, and images showing introduction of game contents or description of game rules are displayed on the upper image display panel 33.

A speaker 29 for outputting a sound is provided on the top box 12. A ticket printer 35, a card reader 36, a data indicator 37, and a keypad 38 are provided under the upper image display panel 33. The ticket printer 35 is for printing on a ticket a barcode showing, in a coded form, data such as a credit value, time and date, an identification number of the gaming machine 10 and the like, and outputting a barcoded ticket 39 thus printed. A player can play a game in another gaming machine using the barcoded ticket 39, and exchange the barcoded ticket 39 with bills or the like at a casher or somewhere else in the game arcade.

The card reader 36 reads data out of a smart card carried, and writes data into the smart card. The smart card is carried by a player. Stored in the smart card are data for identification of the player, data relating to a history of games the player has played, for example.

The data indicator 37 is formed of a fluorescent display and the like. For example, data read out by the card reader 36, data inputted by a player through the keypad 38 are indicated in the data indicator 37. Through the keypad 38, a command or data relating to issue of a ticket or the like are inputted.

[Electrical Construction of Gaming Machine 10]

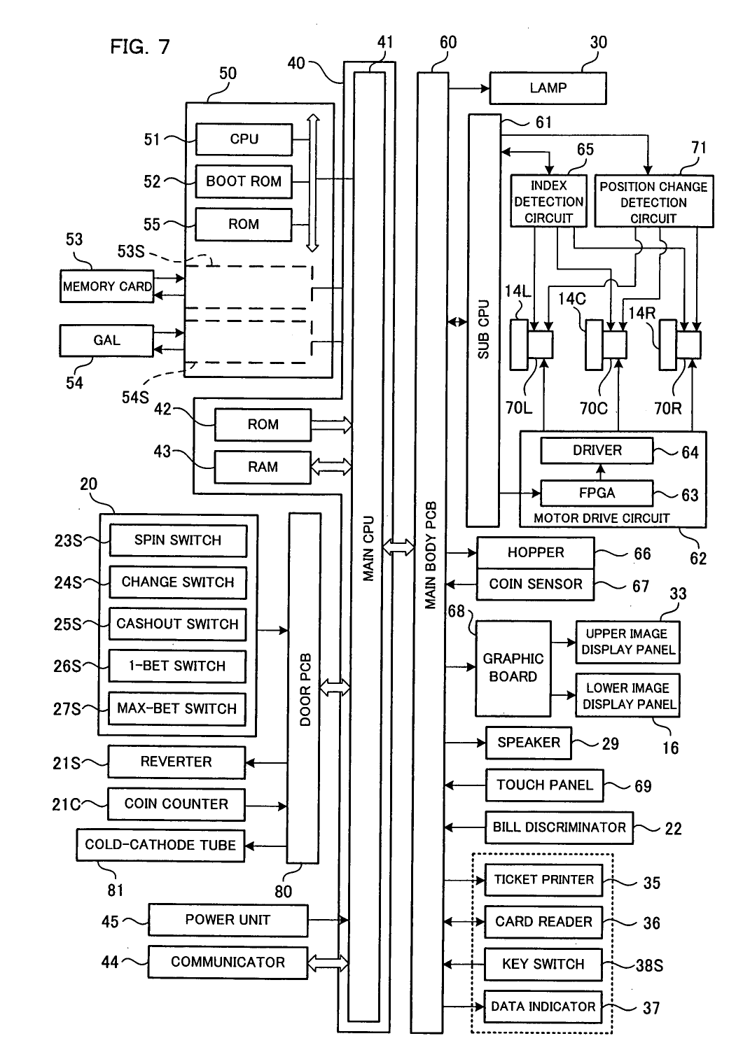

A control unit including the controller 100 shown in FIG. 2 is provided inside the cabinet 11. As shown in FIG. 7, the control unit includes components such as a mother board 40, a main body PCB (Printed Circuit Board) 60, a gaming board 50, a sub CPU 61, a door PCB 80, various switches, and a sensor.

The gaming board 50 includes a CPU (Central Processing Unit) 51, a ROM 55, a boot ROM 52, a card slot 53S, and an IC socket 54S. The CPU 51, the ROM 55, and the boot ROM 52 are connected to each other via an internal bus. The card slot 53S is for a memory card 53. The IC socket 54S is for a GAL (General Array Logic) 54.

A game program and a game system program are stored in the memory card 53. The game program includes a stopped symbol determination program. The stopped symbol determination program is a program for, based on rearrangement symbol data relating to rearrangement symbols determined by the host computer 200, determining a symbol matrix including three symbols 180 which will be stopped on the payline L.

In a case where the gaming machine 10 determines rearrangement symbols by itself, the stopped symbol determination program may include symbol weighting data that correspond to several payout rates such as 80%, 84%, and 88%, respectively. The symbol weighting data indicate, with respect to each of the display windows 15L, 15C, and 15R, a correspondence between a code number of each symbol and one or more random numbers belonging to a predetermined number range (0 to 256).

The payout rate is determined based on payout rate setting data that are outputted from a GAL 54. In a case where the gaming machine 10 determines rearrangement symbols by itself, stopped symbols are determined based on symbol weighting data that correspond to the payout rate.

Various data used for the game program and the game system program are also stored in the memory card 53. To be specific, data indicating a relationship between code numbers and symbols 180 displayed in the display windows 15L, 15C, and 15R shown in FIG. 1 are stored in the form of a data table shown in FIG. 4. These data are transferred to a RAM 43 of the mother board 40 at a time when the game program is executed.

The card slot 53S is adapted to have the memory card 53 inserted therein and removed therefrom, and connected to the mother board 40 via an IDE bus. Accordingly, a kind or contents of a game played in the gaming machine 10 can be changed by removing the memory card 53 from the card slot 53S, writing another game program and another game system program into the memory card 53, and then inserting the memory card 53 into the card slot 53S.

The game program includes a program for progress of a game and a program for shift to a bonus game. The game program also includes image data and sound data outputted during a game.

The GAL 54 has several input ports and output ports. When data are inputted into the input port, the GAL 54 outputs from the output port data corresponding to the inputted data. In a case where the gaming machine 10 determines rearrangement symbols by itself, the data outputted from the output port may be payout rate setting data.

The IC socket 54S is adapted to have the GAL 54 mounted thereto and removed therefrom. The IC socket 54S is connected to the mother board 40 via a PCI bus. Accordingly, payout rate setting data which will be outputted from the GAL 54 can be changed by removing the GAL 54 from the IC socket 54S, rewriting the program stored in the GAL 54, and then mounting the GAL 54 to the IC socket 54S.

The CPU 51, the ROM 55, and the boot ROM 52, which are connected to each other via the internal bus, are connected to the mother board 40 via a PCI bus. The PCI bus carries a signal between the mother board 40 and the gaming board 50, and besides supplies power from the mother board 40 to the gaming board 50. Country identification information and an authentication program are stored in the ROM 55. A preliminary authentication program, a program for the CPU 51 to boot up the preliminary authentication program, which means a boot code, and the like are stored in the boot ROM 52.

The authentication program is a program for authenticating a game program and a game system program. That is, the authentication program is a falsification check program. The authentication program is a program for checking and certifying that the game program and the game system program are not falsified. That is, the authentication program is written in accordance with a procedure of authenticating the game program and the game system program. The preliminary authentication program is a program for authenticating the above-described authentication program. The preliminary authentication program is a program for certifying that the authentication program to be authenticated is not falsified. That is, the preliminary authentication program is written in accordance with a procedure of authenticating the authentication program.

The mother board 40 has a main CPU 41 (controller), a ROM (Read Only Memory) 42, a RAM (Random Access Memory) 43, and a communicator 44.

The main CPU 41 has a function as a controller that controls a whole of the gaming machine 10. In particular, the main CPU 41 performs following controls. That is, when the spin button 23 is pressed after a credit is bet, the main CPU 41 outputs to the sub CPU 61a command signal to rotate the reels 14. After the reels 14 are rotated, the main CPU 41 determines symbols to be stopped. The main CPU 41 makes the determined symbols stopped in the display windows 15L, 15C, and 15R.

That is, the main CPU 41 has a function as an arrangement controller for executing an arrangement control. By the arrangement control, in order to rearrange symbols as a new symbol matrix after the symbols are scrolled in the lower image display panel 16, a symbol matrix corresponding to rearrangement symbol data that relate to rearrangement symbols determined by the host computer 200 is determined, and scrolling symbols are stopped so as to show the symbol matrix thus determined.

In addition, the main CPU 41 has a function as the controller 100 that executes the first processing, the second processing, the third processing, the fourth processing, and the fifth processing. The first processing is to rearrange symbols 180 based on rearrangement symbol data. The rearrangement symbol data relate to rearrangement symbols and are received from the host computer 200 that determines rearrangement symbols for every unit game. The second processing is to give an award based on the rearranged symbols 180. The third processing is to transmit to the host computer 200 a signal indicating that the gaming machine is in operation. The fourth processing is to calculate a payout rate which is a probability that an award will be given. The fifth processing is to transmit to the host computer 200 payout rate data that relate to the payout rate.

A program such as a BIOS (Basic Input/Output System) executed by the main CPU 41 is stored in the ROM 42. In addition, permanent data are also stored in the ROM 42. When the main CPU 41 executes the BIOS, peripheral units are subjected to an initialization process, and the game program and the game system program stored in the memory card 53 start to be captured via the gaming board 50.

Data such as rearrangement symbol data and a program, which are used when the main CPU 41 executes a processing, are stored in the RAM 43. In RAM 43, for example, the symbol memory 108, the display symbol memory 107, and the rearrangement symbol memory 105 shown in FIG. 2 are provided in the form of data areas. The data area for the symbol memory 108 stores therein symbols 180 in the form of the data table shown in FIG. 4. The data area for the rearrangement symbol memory 105 stores therein rearrangement symbols (three symbols placed on the payline L). The data area for the display symbol memory 107 stores therein a symbol matrix including rearrangement symbols.

The communicator 44 performs communication via the internet communication network 300 with the host computer 200 or the like that is provided inside or outside the game arcade. A main body PCB (Printed Circuit Board) 60 and a door PCB 80 are connected to the mother board 40 via USBs (Universal Serial Buses). A power unit 45 is also connected to the mother board 40. When power is supplied from the power unit 45 to the mother board 40, the main CPU 41 of the mother board 40 is started, and further power is supplied through the PCI bus to the gaming board 50 so that the CPU 51 is started.

Equipments and devices that generate an input signal to be inputted to the main CPU 41, and equipments and devices whose operations are controlled in accordance with a control signal outputted from the main CPU 41 are connected to the main body PCB 60 and the door PCB 80. Based on an input signal inputted to the main CPU 41, the main CPU 41 executes the game program and the game system program stored in the RAM 43. Thereby, the main CPU 41 executes a computing processing and stores a result of the processing into the RAM 43, or transmits a control signal to the respective equipments or devices as a control processing over the respective equipments or devices.

A lamp 30, a sub CPU 61, a hopper 66, a coin sensor 67, a graphic board 68, a speaker 29, a touch panel 69, a bill discriminator 22, a ticket printer 35, a card reader 36, a key switch 38S, and a data indicator 37 are connected to the main body PCB 60.

Lighting on/off of the lamp 30 is controlled based on a control signal outputted from the main CPU 41. The sub CPU 61 controls rotating and stopping of the reels 14 (14L, 14C, and 14R). A motor drive circuit 62 including an FPGA (Field Programmable Gate Array) 63 and a driver 64 is connected to the sub CPU 61. The FPGA 63 is an electronic circuit such as a programmable LSI, and functions as a control circuit for stepping motors 70. The driver 64 functions as an amplifier circuit for a pulse which will be inputted to the stepping motors 70. The stepping motors 70 (70L, 70C, and 70R), which rotate the respective reels 14, are connected to the motor drive circuit 62. The stepping motors 70 are of 1-2 phase excitation type.

In the present invention, an excitation mode of a stepping motor is not particularly limited. For example, a 2-phase excitation mode, a 1-phase excitation mode and the like may be adopted. Alternatively, a DC motor may be adopted instead of the stepping motor. In a case where a DC motor is adopted, a deviation counter, a D/A converter, and a servo amplifier are sequentially connected to the sub CPU 61, and the DC motor is connected to the servo amplifier. A rotational position of the DC motor is detected by a rotary encoder, and a current rotational position of the DC motor is, as data, supplied from the rotary encoder to the deviation counter.

In addition, an index detection circuit 65 and a position change detection circuit 71 are connected to the sub CPU 61. The index detection circuit 65 detects a position (i.e., an index which will be described later) of the rotating reels 14. The index detection circuit 65 also detects out-of-step of the reels 14.

The position change detection circuit 71 detects a change of a stopping position of the reels 14 after rotation of the reels 14 is stopped. For example, in a case where a winning combination of symbols is actually not made but nevertheless a player forcibly changes a stopping position so as to make a winning combination of symbols, the position change detection circuit 71 detects a change of a stopping position of the reels 14. The position change detection circuit 71 is adapted to detect a change of a stopping position of the reels 14, for example by detecting fins (not shown) that are attached to an inside portion of the reel 14 at predetermined intervals.

The hopper 66 is placed within the cabinet 11. Based on a control signal outputted from the main CPU 41, a predetermined number of coins are paid out through a coin payout opening 19 into the coin tray 18. The coin sensor 67 is provided inside the coin payout opening 19. When detecting a predetermined number of coins being paid out through the coin payout opening 19, the coin sensor 67 outputs an input signal into the main CPU 41.

The graphic board 68 controls an image display on the upper image display panel 33 and the lower image display panel 16, based on a control signal outputted from the main CPU 41. The graphic board 68 has a VDP (Video Display Processor), a video RAM, and the like. The VDP generates image data based on a control signal outputted from the main CPU 41. Image data generated by the VDP are temporarily stored in the video RAM. Image data used by the VDP for generating image data are included in a game program that has been read out of the memory card 53 and stored in the RAM 43.

The bill discriminator 22 reads an image of a bill, and admits a proper bill into the cabinet 11. When admitting a proper bill, the bill discriminator 22 outputs an input signal to the main CPU 41 based on the amount of the bill. The main CPU 41 stores into the RAM 43 a credit value that corresponds to the amount of bill transmitted by the input signal.

Based on a control signal outputted from the main CPU 41, the ticket printer 35 prints on a ticket a barcode showing, in a coded form, data such as a credit value stored in the RAM 43, time and date, an identification number of the gaming machine 10 and the like, and the ticket printer 35 outputs a barcoded ticket 39 thus printed.

The card reader 36 reads data out of a smart card, and transmits the data to the main CPU 41. The card reader 36 also writes data into a smart card based on a control signal outputted from the main CPU 41. The key switch 38S is provided inside the keypad 38. When the keypad 38 is operated by a player, the key switch 38S outputs an input signal to the main CPU 41. Based on a control signal outputted from the main CPU 41, the data indicator 37 indicates data read out by the card reader 36, data inputted by a player using the keypad 38.

A control panel 20, a reverter 21S, a coin counter 21C, and a cold-cathode tube 81 are connected to the door PCB 80. The control panel 20 includes a spin switch 23S corresponding to the spin button 23, a change switch 24S corresponding to the change button 24, a cashout switch 25S corresponding to the cashout button 25, a 1-BET switch 26S corresponding to the 1-BET button 26, and a MAX-BET switch 27S corresponding to the MAX-BET button 27. When a button 23 to 27 corresponding to each switch is operated by a player, the switch 23S to 27S outputs an input signal to the main CPU 41.

The coin counter 21C is provided inside the coin reception slot 21. The coin counter 21C determines whether a coin inserted into the coin reception slot 21 by a player is a proper one or not. Anything different from a proper coin is ejected from the coin payout opening 19. When detecting a proper coin, the coin counter 21C outputs an input signal to the main CPU 41.

The reverter 21S is operated based on a control signal outputted from the main CPU 41. The reverter 21S distributes coins, which have been determined as proper by the coin counter 21C, to a cash box (not shown) that is placed in the gaming machine 10 or to the hopper 66. In a case where the hopper 66 is filled with coins, the reverter 21S distributes the proper coin to the cash box. In a case where the hopper 66 is not filled with coins, the proper coin is distributed to the hopper 66. The cold-cathode tube 81 is provided on a back side of the lower image display panel 16 and on a back side of the upper image display panel 33. The cold-cathode tube 81 functions as a backlight. The cold-cathode tube 81 is lighted based on a control signal outputted from the main CPU 41.

[Electrical Construction of Host Computer 200]

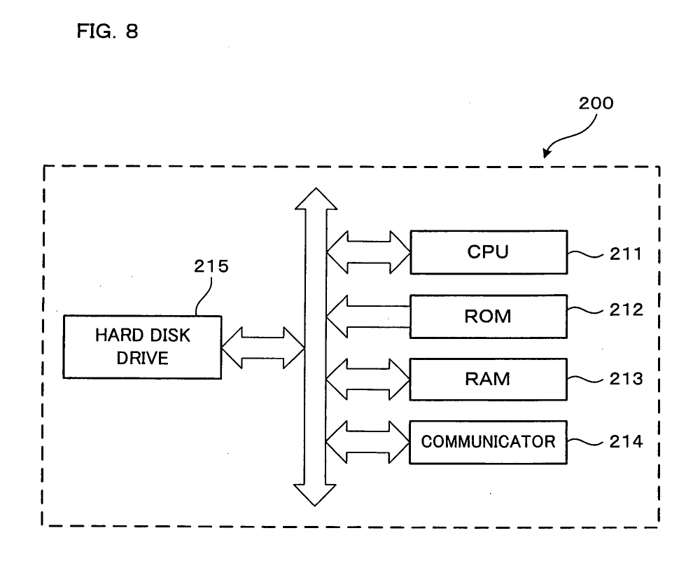

FIG. 8 is a block diagram showing an internal construction of the host computer 200 according to an embodiment of the present invention. The host computer 200 has a CPU 211 as a processing unit, a ROM 212, a RAM 213 as a temporary memory, a communicator 214, and a hard disk drive 215.

By executing a combination determination processing routine which will be described later, the CPU 211 determines rearrangement symbols for every unit game with respect to each gaming machine 10. In addition, based on payout rate data transmitted from each gaming machine 10, the CPU 211 determines rearrangement symbols so as to reduce a payout rate in the gaming machine 10 higher than the predetermined probability (e.g., 70%). Further, by executing a grouping processing routine which will be described later, the CPU 211 calculates the number of in-operation gaming machines 10 using payout rate data transmitted from each gaming machine 10 as an operation signal. When the number of in-operation gaming machines 10 is smaller than a predetermined value (e.g., 100), the CPU 211 determines rearrangement symbols for every game with respect to each gaming machine 10. On the other hand, when the number of in-operation gaming machines 10 is greater than the predetermined value, the CPU 211 divides all gaming machines 10 into several groups and determines rearrangement symbols for every game with respect to each group.

The communicator 214 is connected to the communicator 44 of each gaming machine 10 communicably through the internet communication network 300. The RAM 213 temporarily stores therein data such as a payout rate received from each gaming machine 10, and data such as rearrangement symbol data to be transmitted to each gaming machine 10. The ROM 212 stores therein a system program for controlling an operation of a control unit, permanent data, and the like. The hard disk drive 215 stores therein rearrangement symbols for every unit game that are determined for each gaming machine 10 and associated with the gaming machine 10.

[Result of Determination of Rearrangement Combination]

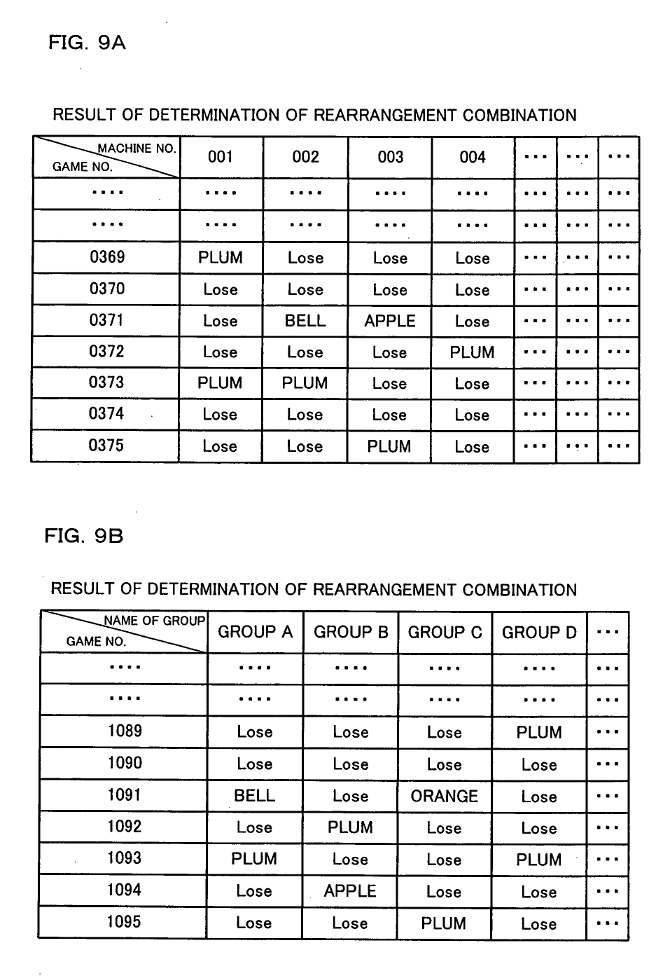

FIGS. 9A and 9B schematically show an example of a table that indicates, for each game No., rearrangement symbols determined for every game with respect to each gaming machine 10. The table is stored in the hard disk drive 215. FIG. 9A shows an example of a table in a case where rearrangement symbols are determined for each gaming machine 10. For example, in game No. 375, a rearrangement combination for machine No. 001 is determined to be “Lose”, and a rearrangement combination for machine No. 003 is determined to be “PLUM”. The rearrangement combination means a combination stopped on the payline L when symbols are rearranged. The “Lose” means a combination other than the winning combination. In this embodiment, the host computer 200 determines, as rearrangement symbols, a combination which will be stopped on the payline L (only three symbols). However, it may be possible that the host computer 200 determines a symbol matrix including three columns and three rows.

FIG. 9B shows an example of a table in a case where rearrangement symbols are determined for each group. For example, in game No. 1095, a rearrangement combination for group A is determined to be “Lose”, and a rearrangement combination for group C is determined to be “PLUM”.

[Processing Operation of Gaming Machine 10]

Next, a processing executed in the gaming machine 10 will be described. The main CPU 41 reads and executes the game program, and thereby a game progresses.

[Signal Reception Processing]

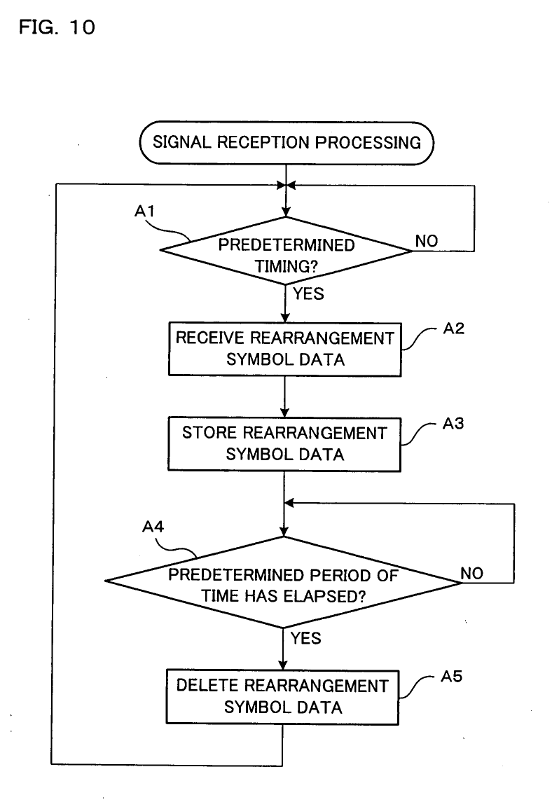

The main CPU 41 of the gaming machine 10 executes a signal reception processing routine shown in FIG. 10, at regular intervals. First, whether it is a predetermined timing or not is determined (A1). When it is not a predetermined timing (A1: NO), the step A1 is performed again and a standby state continues until the predetermined timing comes. When it is a predetermined timing (A1: YES), rearrangement symbol data are received from the host computer 200 (A2), and the rearrangement symbol data are stored in the RAM 43 (A3).

Then, whether a predetermined period of time has elapsed or not is determined (A4). The predetermined period of time is a period of time required for a unit game. When the predetermined period of time has not elapsed (A4: NO), the step A4 is performed again and a standby state continues until the predetermined period of time elapses. When the predetermined period of time has elapsed (A4: YES), the rearrangement symbol data stored in the RAM 43 are deleted (A5), and the processing returns to A1. In this way, rearrangement symbol data stored in the RAM 43 are updated at regular intervals, irrespective of whether a game is played in the gaming machine 10 or not.

[Game Execution Processing]

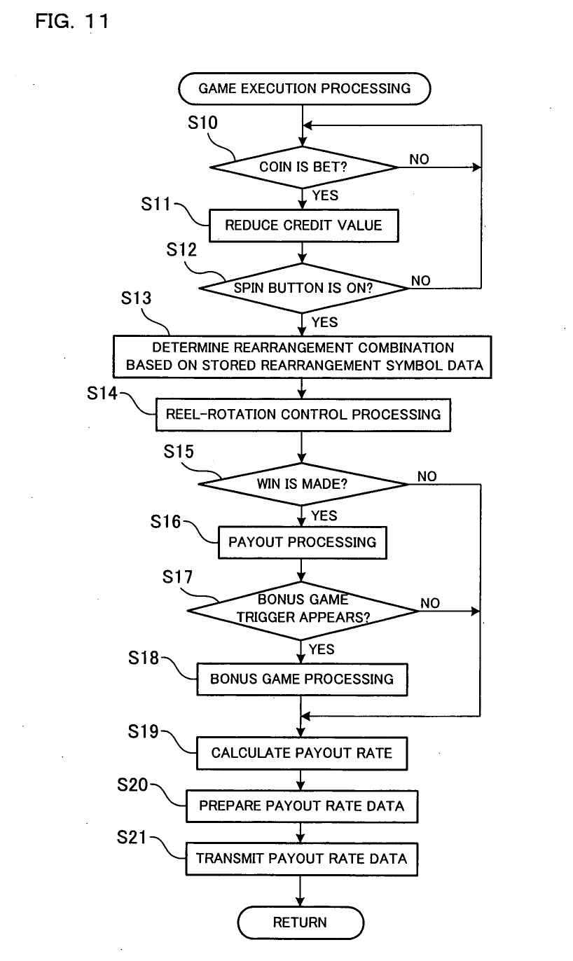

Concurrently with the signal reception processing routine, the main CPU 41 of the gaming machine 10 executes a game execution processing routine shown in FIG. 11. In a game execution processing, first, whether a coin has been bet or not is determined (S10). In this step, whether an input signal from the 1-BET switch 26S, which is produced when the 1-BET button 26 is pressed, has been received or not is determined, and at the same time whether an input signal from the MAX-BET switch 27S, which is produced when the MAX-BET button 27 is pressed, has been received or not is determined. When a coin has not been bet (S10: NO), the step S10 is performed again, and a standby state continues until a coin is bet.

When a coin has been bet (S10: YES), a credit value stored in the RAM 43 is reduced in accordance with the number of coins bet (S11). When the number of coins bet is greater than the credit value stored in the RAM 43, the step S11 is performed again without performing the step for reducing the credit value. When the number of coins bet exceeds a maximum value (which is 50 in this embodiment) bettable on one game, step S12 is performed without performing the step for reducing the credit value.

Then, whether the spin button 23 is turned on or not is determined (S12). When the spin button 23 is not turned on (S12: NO), the processing returns to S10. In a case where the spin button 23 is not turned on, for example in a case where the spin button 23 is not turned on but a command to end a game is inputted, a result of reduction performed in S11 is canceled.

When the spin button 23 is turned on (S12: YES), a rearrangement combination is determined based on rearrangement symbol data stored in the RAM 43 (S13). That is, by executing the stopped symbol determination program stored in the RAM 43, a symbol matrix including three symbols 180 which will be stopped on the payline L is determined.

Like this, a rearrangement combination is determined by the host computer 200. Therefore, by managing the host computer 200, a casino or the like can easily grasp a state of giving of awards from the gaming machines 10.

Next, a reel-rotation control processing is executed to rotate the reels 14L, 14C, and 14R. Thereby, symbols 180 are scrolled in the display windows 15L, 15C, and 15R as shown in FIG. 1 (S14). The reel-rotation control processing is to scrolling the reels 14L, 14C, and 14R in an arrowed direction and then stop (rearrange) a combination determined in S13 on the payline L.

Then, whether a win is made or not, that is, whether a combination of symbols 180 stopped on the payline L is a winning combination or not, is determined (S15). When it is a winning combination (S15: YES), a payout processing is executed (S16). More specifically, the number of coins to be paid out based on a win corresponding to the winning combination is calculated. In a case where the coins to be paid out are reserved, a predetermined credit value is added to the credit value stored in the RAM 43. In a case where the coins are paid out, a control signal is transmitted to the hopper 66, so that a predetermined number of coins are paid out.

Then, whether a bonus trigger appears as the winning combination or not is determined (S17). More specifically, whether an “APPLE” combination appears on the payline L or not is determined. When it is determined that a bonus trigger appears (S17: YES), a bonus game processing is executed (S18).

When it is not a winning combination (S15: NO), when it is determined that a bonus trigger does not appear (S17: NO), or after step S18, a payout rate is calculated (S19), and payout rate data are made based on the payout rate (S20). Then, the payout rate data are transmitted to the host computer 200 (S21), this routine is ended.

[Processing Operations of Host Computer 200]

Next, a processing executed in the host computer 200 will be described.

[Grouping Processing]

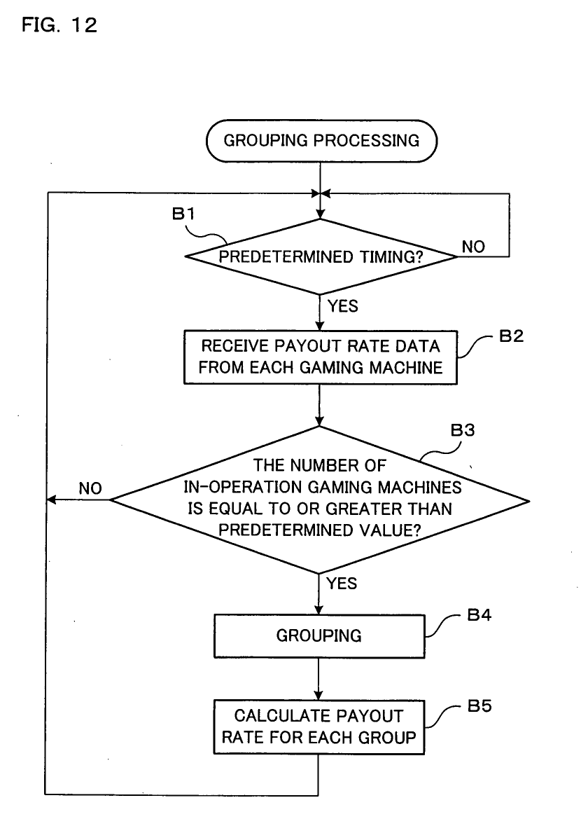

First, the CPU 211 of the host computer 200 executes a grouping processing routine shown in FIG. 12 at regular intervals. First, whether it is a predetermined timing or not is determined (B1). When it is not a predetermined timing (B1: NO), the step B1 is performed again and a standby state continues until the predetermined timing comes. When it is a predetermined timing (B1: YES), payout rate data are received from each gaming machine 10 (B2). The payout rate data serve as an operation signal, and whether the number of in-operation gaming machines 10 is equal to or greater than a predetermined value or not is determined (B3). When the number of in-operation gaming machines 10 is neither equal to nor greater than a predetermined value (e.g., 100) (B3: NO), the processing returns to B1. When the number of in-operation gaming machines 10 is equal to or greater than a predetermined value (B3: YES), the in-operation gaming machines 10 are divided into several groups (B4), and a payout rate is calculated for each group (B5). Then, the processing returns to B1.

[Combination Determination Processing]

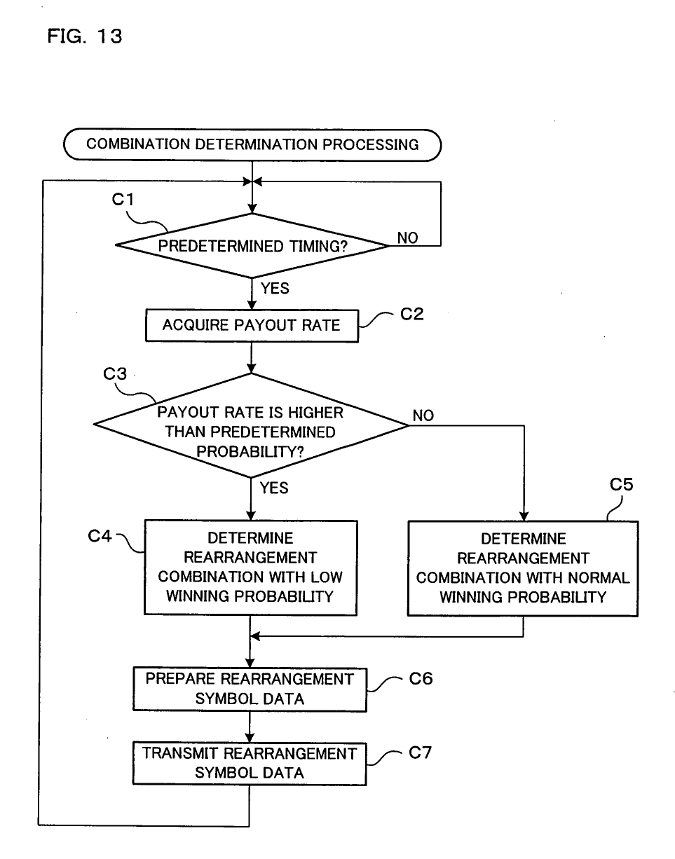

The CPU 211 of the host computer 200 executes a combination determination processing routine shown in FIG. 13 at regular intervals. First, whether it is a predetermined timing or not is determined (C1). When it is not a predetermined timing (C1: NO), the step C1 is performed again and a standby state continues until the predetermined timing comes. When it is a predetermined timing (C1: YES), a payout rate is acquired (C2). Here, in a case where the gaming machines 10 are divided into several groups by the grouping processing routine shown in FIG. 12, a payout rate for each group is acquired. On the other hand, in a case where the gaming machines 10 are not divided into groups, a payout rate for each gaming machine 10 is acquired.

Then, whether the payout rate is higher than a predetermined probability or not is determined (C3). When the payout rate is higher than a predetermined probability (C3: YES), a rearrangement combination is determined with a lower probability that a winning combination will be made (C4). In a case where the gaming machines 10 are divided into several groups by the grouping processing routine shown in FIG. 12, a rearrangement combination is determined for each group. On the other hand, in a case where the gaming machines 10 are not divided into groups, a rearrangement combination is determined for each gaming machine 10. As a result, in the gaming machine 10 presenting a payout rate higher than the predetermined probability, the payout rate can be reduced. When the payout rate is not higher than a predetermined probability (C3: NO), a rearrangement combination is determined with a normal probability that a winning combination will be made (C5). In a case where the gaming machines 10 are divided into several groups by the grouping processing routine shown in FIG. 12, a rearrangement combination is determined for each group. On the other hand, in a case where the gaming machines 10 are not divided into groups, a rearrangement combination is determined for each gaming machine 10.

When many gaming machines 10 are in operation, a burden is put on a processing capacity of the host computer 200 that determines rearrangement symbols (combination) for each gaming machine 10. However, since the host computer 200 divides all the gaming machines 10 into several groups and determines rearrangement symbols for each group, the burden put on the processing capacity of the host computer 200 can be reduced. In addition, by reflecting the payout rate to the host computer 200, the payout rate in the gaming machine 10 higher than the predetermined probability can be reduced. As a result, the number of games to be played by a player desiring a large amount of award can be increased, and therefore an operation rate of the gaming machine 10 can be increased.

After step C4 or C5, rearrangement symbol data are made (C6), and transmitted (C7). Then, the processing returns to C1.

Although the above descriptions have been provided with regard to the characteristic parts so as to understand the invention more easily, the invention is not limited to the embodiments as described above and can be applied to the other embodiments and the applicable scope should be construed as broadly as possible. Furthermore, the terms and phraseology used in the specification have been used to correctly illustrate the invention, not to limit it. In addition, it will be understood by those skilled in the art that the other structures, systems, methods and the like included in the spirit of the invention can be derived from the spirit of the invention described in the specification. Accordingly, it should be considered that the invention covers equivalent structures thereof without departing from the spirit and scope of the invention as defined in the following claims. Further, the abstract is provided so that an intellectual property office and a general public institution or one skilled in the art who is not familiar with patent and legal or professional terminology can quickly analyze the technical features and essences of the invention through a simple investigation. Accordingly, the abstract is not intended to limit the scope of the invention that should be evaluated by the claims. In addition, it is required to sufficiently refer to the documents that have been already disclosed, so as to fully understand the objects and effects of the invention.

The above descriptions include a process that is executed on a computer or computer network. The above descriptions and expressions have been provided so that the one skilled in the art can understand the invention most effectively. In the specification, the respective steps used to induce one result or blocks having a predetermined processing function should be understood as a process having no self-contradiction. In addition, the electrical or magnetic signal is transmitted/received and written in the respective steps or blocks. Although the processes in the respective steps or blocks embody the signal as a bit, value, symbol character, term, number and the like, it should be noted that these have been used for the convenience of descriptions. Further, although the processes in the respective steps or blocks have been often described as an expression common to a human action, the process described in the specification is executed by a variety of devices in principle. In addition, the other structures necessary for the respective steps or blocks are apparent from the above descriptions.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A gaming machine comprising:
a display on which a plurality of symbols are arranged;
a communication device that is data-communicably connected to a host computer that determines rearrangement symbols for every unit game; and
a controller programmed to perform operations of:
(a) rearranging the plurality of symbols based on a rearrangement symbol data item that relates to the rearrangement symbols received by the communication device from the host computer; and
(b) giving an award based on the plurality of symbols thus rearranged.

2. A gaming machine comprising:
a display on which a plurality of symbols are arranged;
a communication device that is data-communicably connected to a host computer, wherein the host computer determines rearrangement symbols for every unit game with respect to each gaming machine in a case where the number of in-operation gaming machines is smaller than a predetermined value, while the host computer divides all gaming machines into a plurality of groups and determines rearrangement symbols for every unit game with respect to each group in a case where the number of in-operation gaming machines is greater than the predetermined value; and
a controller programmed to perform operations of:
(a) transmitting a signal indicating that the gaming machine is in operation, from the communication device to the host computer;
(b) rearranging the plurality of symbols based on a rearrangement symbol data item that relates to the rearrangement symbols received by the communication device from the host computer; and
(c) giving an award based on the plurality of symbols thus rearranged.

3. A gaming machine comprising:
a display on which a plurality of symbols are arranged;
a communication device that is data-communicably connected to a host computer, wherein the host computer determines rearrangement symbols for every unit game, and determines the rearrangement symbols so as to reduce a payout rate, which is a probability that an award will be given, in a case where the payout rate is higher than a predetermined probability; and
a controller programmed to perform operations of:
(a) transmitting a payout rate data item that relates to the payout rate, from the communication device to the host computer;
(b) rearranging the plurality of symbols based on a rearrangement symbol data item that relates to the rearrangement symbols received by the communication device from the host computer;
(c) giving an award based on the plurality of symbols thus rearranged; and
(d) calculating the payout rate.

4. A gaming machine comprising:
a display on which a plurality of symbols are arranged;
a communication device that is data-communicably connected to a host computer, wherein the host computer determines rearrangement symbols for every unit game with respect to each gaming machine in a case where the number of in-operation gaming machines is smaller than a predetermined value, while the host computer divides all gaming machines into a plurality of groups and determines rearrangement symbols for every unit game with respect to each group in a case where the number of in-operation gaming machines is greater than the predetermined value, and in addition the host computer determines the rearrangement symbols so as to reduce a payout rate, which is a probability that an award will be given, in a case where the payout rate is higher than a predetermined probability; and
a controller programmed to perform operations of:
(a) transmitting a signal indicating that the gaming machine is in operation and a payout rate data item that relates to the payout rate, from the communication device to the host computer;
(b) rearranging the plurality of symbols based on a rearrangement symbol data item that relates to the rearrangement symbols received by the communication device from the host computer;
(c) giving an award based on the plurality of symbols thus rearranged; and
(d) calculating the payout rate.

5. A playing method of a gaming machine wherein a controller repeatedly performs a unit game in which a plurality of symbols arranged on a display are rearranged, the method comprising the steps of:
(a) rearranging the plurality of symbols based on a rearrangement symbol data item that relates to rearrangement symbols received from a host computer that determines rearrangement symbols for every unit game; and
(b) giving an award based on the plurality of symbols thus rearranged.

6. A playing method of a gaming machine wherein a controller repeatedly performs a unit game in which a plurality of symbols arranged on a display are rearranged, the method comprising the steps of:
(a) transmitting to a host computer a signal indicating that the gaming machine is in operation, wherein the host computer determines rearrangement symbols for every unit game with respect to each gaming machine in a case where the number of in-operation gaming machines is smaller than a predetermined value, while the host computer divides all gaming machines into a plurality of groups and determines rearrangement symbols for every unit game with respect to each group in a case where the number of in-operation gaming machines is greater than the predetermined value;
(b) rearranging the plurality of symbols based on a rearrangement symbol data item that relates to the rearrangement symbols received from the host computer; and
(c) giving an award based on the plurality of symbols thus rearranged.

7. A playing method of a gaming machine wherein a controller repeatedly performs a unit game in which a plurality of symbols arranged on a display are rearranged, the method comprising the steps of:
(a) calculating a payout rate which is a probability that an award will be given;
(b) transmitting to a host computer a payout rate data item that relates to the payout rate, wherein the host computer determines rearrangement symbols for every unit game, and determines the rearrangement symbols so as to reduce the payout rate in a case where the payout rate is higher than a predetermined probability;
(c) rearranging the plurality of symbols based on a rearrangement symbol data item that relates to the rearrangement symbols received from the host computer; and
(d) giving an award based on the plurality of symbols thus rearranged.

8. A playing method of a gaming machine wherein a controller repeatedly performs a unit game in which a plurality of symbols arranged on a display are rearranged, the method comprising the steps of:
(a) calculating a payout rate which is a probability that an award will be given;
(b) transmitting to a host computer a signal indicating that the gaming machine is in operation and a payout rate data item that relates to the payout rate, wherein the host computer determines rearrangement symbols for every unit game with respect to each gaming machine in a case where the number of in-operation gaming machines is smaller than a predetermined value, while the host computer divides all gaming machines into a plurality of groups and determines rearrangement symbols for every unit game with respect to each group in a case where the number of in-operation gaming machines is greater than the predetermined value, and in addition the host computer determines the rearrangement symbols so as to reduce the payout rate in a case where the payout rate is higher than a predetermined probability;
(c) rearranging the plurality of symbols based on a rearrangement symbol data item that relates to the rearrangement symbols received from the host computer; and
(d) giving an award based on the plurality of symbols thus rearranged.
